(19) United States
(12) Patent Application Publication
(10) Pub. No.: US 2012/0296799 A1
(43) Pub. Date: Nov. 22, 2012

(54) SYSTEM, METHOD AND COMPUTER PROGRAM FOR ENERGY USE MANAGEMENT AND REDUCTION

(76) Inventors: Phillip Andrew Ross Playfair, Toronto (CA); Steven Ronald Fredrick Nelson Hammond, Markham (CA)

(21) Appl. No.: 13/514,800

(22) PCT Filed: Dec. 10, 2010
(86) PCT No.: PCT/CA2010/001968

§ 371 Date: Aug. 9, 2012

Related U.S. Application Data
(60) Provisional application No. 61/285,257, filed on Dec. 10, 2009.

(51) Int. Cl. G06Q 50/00; G06Q 40/04; G06Q 40/00

(52) U.S. Cl. 705/37; 705/35

(57) ABSTRACT

The present invention provides a system, method and computer program for energy use management and reduction. The invention enables managing and reducing energy usage by monitoring energy usage of users and rewarding users for reducing energy usage. It includes monitoring energy consumption for users. Any reduction in energy consumption is commoditized. The commoditized energy can be sold on a market. Some or all of the revenues realized from the sale may be distributed to the users as encouragement to further reduce energy usage.

The present application claims priority benefit to U.S. patent application Ser. No. 61/285,257, filed Dec. 10, 2009, which is incorporated herein by reference.

### FIELD OF THE INVENTION

The present invention relates generally to reducing energy consumption. The present invention relates more specifically to monitoring energy consumption, suggesting means by which to reduce consumption, monitoring reduction, and encouraging reduction.

### BACKGROUND TO THE INVENTION

Climate change is currently a leading political and social concern. Governments and individuals are mindful of making responsible decisions with respect to energy conservation and energy efficiency. Governments have introduced or considered introducing carbon tax and trading schemes that create financial incentives for businesses to encourage them to reduce energy usage and carbon emissions.

Meanwhile, consumer or residential energy usage has also been addressed in some business models. Business models for delivering energy have changed in an effort to encourage prudent usage of energy. For example, variable pricing based on time of day or day of week has been introduced in some jurisdictions to encourage household energy usage during off-peak hours.

Furthermore, a number of technologies have been introduced to further encourage efficient energy usage, including smart meters and devices that use less energy than its predecessors, such as LED-lights and light switch timers.

There are a number of patents and patent applications dealing with the measurement of electrical energy use in buildings and by electrical appliances. U.S. Pat. No. 5,894,422 describes a smart-meter system that measures the energy usage of a building on an hourly basis. This information is transmitted to the supplier's generator site and can be used to adjust the supplier's voltage to make the power flow equal to consumer demand. The information is also used to calculate the total energy consumed in a billing period. While this patent describes the use of smart-meters to monitor household energy consumption and the energy supply from a utility, it does not discuss reducing energy consumption or converting energy and emission reductions into tradable commodities.

U.S. Pat. No. 5,519,622 describes a method of presenting energy consumption to consumers by first gathering energy use information and then calculating the real time price differences during peak periods of energy use in comparison to off-peak periods and surcharges, then presenting this information through a red-light/green-light system that is easy for consumers to understand. However, it does not discuss a method for reducing energy consumption, or a method to convert energy and emission reductions into tradable commodities.

There are also a number of patents and patent applications directed towards carbon emission trading. For instance, U.S. Pat. No. 6,904,336 and U.S. patent application Ser. No. 10/290,754 describe a system and method for quantifying reductions in residential carbon emissions and reductions in energy usage through the steps of: measuring the energy savings resulting from an energy savings opportunity in a residential property, determining the baseline residential energy usage and carbon emission, calculating the emissions reduction resulting from the reduction in baseline energy usage, monitoring the residential energy savings opportunities, monitoring the quantification of the emissions reduction, verifying the quantification of the emissions reduction, aggregating a plurality of emissions reductions into a tradable commodity, and trading the tradable commodity in commodity markets. They describe not only the management of energy usage by residential properties through upgrades made to residential properties and appliances, but also the reduction of energy supplied by utility companies to residential properties as a result of these upgrades. However, neither considers a reduction in peak energy usage, how the profits of emissions trading can be applied, or any mechanism that encourages the continued use of the invention and further reductions in energy usage. In addition, neither describes a mechanism that facilitates communication between the invention and the user.

U.S. patent application Ser. No. 12/400,739 and related U.S. patent application Ser. No. 12/347,818 describe a method of measuring and monitoring the usage of utilities and valuating the energy savings as compared to a baseline value. U.S. patent application Ser. No. 12/400,739 also describes the quantification of utility savings in building construction and the application of these savings to securities investments, as credit in financial transactions and as part of early repayment of mortgages. The energy savings can be converted into a carbon credit, which can be applied to the financial transaction. It also describes the use of a web server that is connected to a client interface which would allow the user to view and monitor utility usage data and savings calculations. However, while it considers obtaining energy savings and carbon credits from the utilities' angle, and the bundling of energy savings from different sources, it does not describe a mechanism to validate the energy savings.

U.S. patent application Ser. No. 12/607,959 describes methods, systems, apparatus, and tangible computer-readable media for receiving resource consumption information associated with a consumer from a resource consumption validator, analyzing the received information and storing the received information and/or the analysis results are herein provided. In some cases, an environmental impact associated with a consumer's resource consumption is determined. Methods, systems, apparatus, and tangible computer-readable media for automatically accessing a consumer resource consumption account and retrieving resource consumption information associated with the resource consumption account are also provided. However, it does not contemplate peak reductions, only month to month usage. It also provides no mechanism for enabling commoditization of energy savings among users of the invention.

What is required therefore, is a system for reducing energy usage while enabling a user to validate his or her reduction in energy consumption, aggregate energy savings from different sources, convert energy reduction to tradable commodities, provide incentives for users to continue to reduce their energy consumption, facilitate communication with users of energy saving strategies to encourage further reductions and provide a recurring revenue stream to encourage participants to maintain or enhance their reduction efforts.

### SUMMARY

The present invention provides a computer implemented method of managing and reducing energy usage, the method characterized by: (a) establishing a base line energy consumption for one or more users; (b) monitoring, by means of one or more energy monitoring devices, energy consumption for the one or more users; (c) providing access to one or more tools by operation of a computer system, that enable the one or more users to reduce their energy consumption; (d) determining energy savings by operation of the computer system by calculating reduction in energy consumption based on the base line energy consumption for the one or more users; and (e) aggregating the energy savings across a plurality of users, and commoditizing the energy savings by operation of the computer system.

The present invention also provides a system for managing and reducing energy usage, the system characterized by: (a) one or more energy monitoring devices operable to monitor energy consumption for one or more users; (b) a server linked to the one or more energy monitoring devices, the server operable to: (i) establish a base line energy consumption for the one or more users; (ii) provide access to one or more tools for enabling the one or more users to accomplish reduction in their consumption of energy; (iii) validate energy savings resulting from the reduction in consumption by the one or more users based on the base line energy consumption for the one or more users; and (iv) aggregate the energy savings across a plurality of users, and commoditize by operation of the computer system.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 illustrates a system in accordance with the present invention.

FIG. 2 illustrates a method in accordance with the present invention.

FIG. 3 illustrates a user verification routine.

FIG. 4 illustrates a user configuring the system by providing profile information for energy consuming devices.

FIG. 5 illustrates a provider usage verification process.

FIG. 6 illustrates a user providing usage data.

FIG. 7 illustrates the calculation of baseline usage.

FIG. 8 illustrates the calculation of an aggregated baseline taking into account all energy modalities.

FIG. 9 illustrates an aggregated baseline for the modalities “water”, “gas”, “electric” and “other” for a one year period.

FIG. 10 illustrates an emission reduction process.

FIG. 11 illustrates aggregated energy reduction achieved by a network of users.

FIG. 12 illustrates a virtual power plant.

### DETAILED DESCRIPTION

The present invention provides a system, method and computer program for energy use management and reduction. The invention enables managing and reducing energy usage by monitoring energy consumption for one or more users, commoditizing energy savings resulting from a reduction in the energy consumption by the one or more users, creating an internal market to trade the commoditized energy, reselling the commoditized energy on the open market, and distributing revenues from the reselling to the one or more users. Reduction in energy savings is also achieved by publishing particular users' energy savings, thus providing psychological incentive for each user to further reduce usage.

The system of the present invention enables users to determine energy usage for a location (such as a household), including by determining the particular energy usage of one or more energy consuming devices at the location. The system is linked to the energy monitoring devices for monitoring energy usage and is further linked to one or more databases for recording historical measures of the monitored energy. The energy monitoring devices track energy usage of one or more energy modalities, including for example electricity, water, natural gas and/or oil.

A user, an administrator of the system, or an energy provider may configure the system including by providing usage and costing information (such as constant price per energy unit or variable price per unit based on time of day, day of week, etc.). The system may provide the user with analytic information including based on energy usage and/or cost breakdown for a given time period. The system may also provide predictive modeling and suggestions for enabling the user to reduce his or her energy consumption.

A user may also configure the system by providing energy consuming device profile information. The profiles may correspond to models of energy usage for each of the user's energy consuming devices. The analytic information may consider the profiles to enable users to better understand the particular causes of energy consumption.

Correspondingly, the system is operable to enable users to determine best practices for reducing energy consumption and/or energy cost. The system may determine better allocations of energy usage based on the profile information and optionally costing information. The system may suggest to a user that it replace one or more of the energy consuming devices with other devices for which profiles are available or alter the user's behaviour with respect to usage of one or more of the energy consuming devices. The analytic information may enable the system to generate predictive models for predicting future energy consumption and/or energy cost based on adopting the suggestions.

Based in part on these reductions, the system may also include a trading utility for enabling trading of currency (energy credits) on an internal market based on the energy consumption reductions achieved by the users. Trading commoditized energy savings serves as incentive for each user to reduce energy usage. Users are further encouraged to reduce energy savings by publication of energy savings to the community of users, which provides psychological incentive to users to reduce energy consumption. The trading utility also enables the energy consumption reduction of all users to be aggregated into a community energy reduction, which can be commoditized on the open market.

Commoditization on the internal and open markets may reward users with currency (or loyalty points) that may be exchangeable for legal tender or for further use on the internal market. The amount of currency rewarded may vary based on the need for reduction at any given time. For example, a relatively high reward may be obtained for reducing consumption on demand during overall peak energy usage (i.e. high usage among all users), which may be referred to as peak energy shaving. The users may also purchase currency units from the internal market to balance expected or incurred increases in energy usage. The trading utility may also enable buying, selling and trading of advertising, electricity, natural gas, propane, water, petrol, heating oil, carbon, potential carbon reduction, potential energy reduction, potential water reduction and financial reserves.

The system is operable to empower registered users to acts as a supplier of a resource in the supply chain. In a particular implementation of the invention, the system is operable to enable registered users to in effect supply to the operator of the system, through their use of the system, one or more commodities including: advertising potential, kilowatts of energy, water reductions, and carbon reductions. The system of the present invention provides an exchange/trading mechanism (by operation of the trading utility described below) where the operator of the system monetizes these commodities on behalf of the users, for example for best value. The revenue generated is returned to the member less a fee by the operator of the system.

In one particular implementation of the present invention, the currency used is an electronic “credit” administered by the system of the present invention, applied and distributed for example by operation of the web application of the present invention. The value of the credit may be established arbitrarily by the operator of the system or can be allowed to fluctuate using the ongoing trading of the above listed commodities and demand for credits, to establish its value.

Registered users may receive such credits when they agree to enable advertising to be placed on a dashboard or other web pages presented by operation of the system of the present invention, giving the operator of the system the right to advertise in content generated using the platform enabled by the system including emails, text messages, news feeds, social media updates, and web pages.

The extent to which a registered user receives benefits from permitting advertising content to be displayed in media generated by operation of the system of the invention. The extent to which the registered user benefits from advertising content generated by operation the system depends on the extent to which the registered user agrees to the placement of such content, by operation by a series of permissions enabled by the system. The system may be associated with an advertising engine for the purpose of the placement and/or creation of such content.

It should be noted that the advertising content may include: web Impressions, mobile impressions, text (SMS) Impressions, web clicks, mobile clicks, text (SMS) clicks, newsfeed display text/links, newsfeed display text/link logo, lowfoot newsffeed display click through, Facebook display text/link, Facebook display text/link logo, Twitter display text/link, other social media content.

By operation of the present system, registered users may also be “paid” using credits based on the units of resources they are able to produce through their savings within a specific period of time, for example units of electricity, gas and water.

It should be noted that the present invention contemplates the credits being convertible into a number of benefits whether for example electronic cash payments, coupons to obtain goods and services from third parties, or other benefits.

The extension of benefits based on user behavior facilitated by the system of the present invention may in part be conferred in a way that meets demand management/demand response goals. The tools used to enable demand management/demand response are further described below.

For example, registered users of the system may earn credits when they successfully supply measurable electricity reductions during peak periods. The number of credits a registered user may earn will depend on the price per kilowatt and the number of kilowatts reduced. The system of the present invention may be configured so as to address variation based on the parameters of specific utilities and/or associated rules and regulations in specific jurisdictions. In one particular aspect of the present invention, the sale of peak reductions realized by operation of the system, helps to fund the credits mentioned earlier.

More specific aspects of demand management include:

1) Measurable Kilowatt reduction of base load as compared to a baseline

2) Measurable Kilowatt reduction during peak periods (mid, on, shoulder etc;)

3) Measurable Kilowatt reductions or kilowatt usage increases to assist with load balancing

It should be understood that the system may enabled registered users to earn credits for reducing or shifting usage (to non peak periods for example) of other commodities such as natural gas and water. The number of credits a member will earn will depend on the price per unit and the number of units reduced or shifted. The operation of the system may sell the reduction and load shifts to the appropriate jurisdictions or organizations for the best value. Some example of reductions and load shifting include:

1) Measurable reduction of energy units as compared to a baseline

2) Measurable reduction (or increases) of energy units on demand or during agreed upon time periods

By operation of the system of the present invention, registered users may also earn credits when they engage in certain activities or behavioral changes that can be measured and validated to reduce Green House Gas emissions. The system is operable to validate these reductions and then sell them for example using an available carbon exchange or offset mechanism. The baseline discussed in further detail below may be used to enable the validation of Green House Gas emissions.

It should be understood that any person, organization, or corporation can become a registered user of the operation of the system. Registered users may buy credits in return of certain activities, as mentioned above, which may include permitting placement of advertising, offsetting energy trading and points sponsorship.

Also, a registered users may choose to give their credits to another registered user, whether another registered user having difficulty meeting their goals, or a not for profit entity or charity that has become a registered user for the purpose of engaging in promotional activities through the community created by operation of the system, and to receive benefits associated with assignment of credits through the platform.

Credits can only be bought and sold by operation of the system of the present invention.

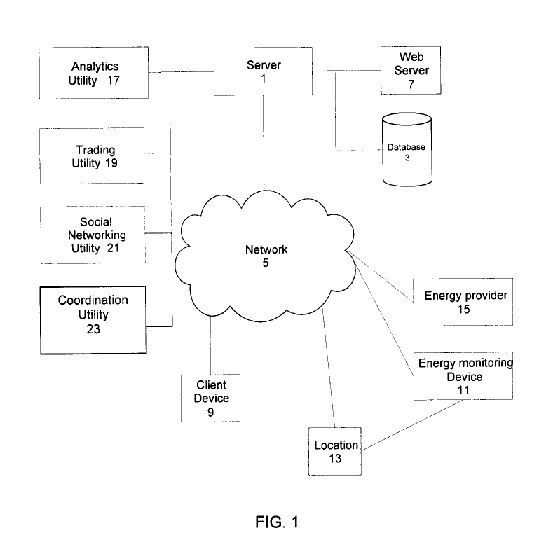

FIG. 1 illustrates a system in accordance with the present invention. The system may include a network accessible computer server 1 linked to a database 3. The network 5 may be the Internet.

The computer server 1 may include or be linked to a web server 7 for providing a web interface enabling a user to provide information to the server 1.

The server 1 may further be linked to an analytics utility 17 and a trading utility 19. The analytics utility 17 may provide analytic information on energy usage and reduction based on observed and/or predicted energy usage patterns for one or more users. The trading utility 19 administers an internal energy trading market of the present invention and makes currency available on the open market.

A social networking utility 21 may also be linked to the server 1. The social networking utility 21 may either implement a social network in which users are member of the social network, or interface with an existing social network.

The server 1 may additionally be linked to a coordination utility 23 that is operable to manage aggregate demand. The coordination utility 23 may manage aggregate demand based on various usage schedules provided by users or determined by the analytics utility 17 based on user behaviour. The coordination utility 23 may be configured to manage demand so as to optimally allocate usage to prevent damage to infrastructure. For example, the coordination utility 23 may turn energy consuming devices on in a staggered process to prevent energy spikes, and/or turn energy consuming devices off based on infrastructure operating at near-maximum levels.

The user may access the server 1 over the network 5 from a client device 9, which may be a computer or mobile device, such as a smart phone. The user may access the server 1 through a web browser or other interface accessible from the client device 9, which communicates with the web server 7. Suggestions and alerts may be some of the notifications provided via the interface. The user may configure the system to specify the particular client device to which to deliver suggestions and alerts. For example, a mobile device may be specified by phone number for delivering SMS alerts. The user may configure a number of different alerts and tolerances that they want to receive from the software when monitoring their usage and peak electrical usage.

The present invention may include a mobile device component, which may be implemented as a mobile client computer program operable to interoperate with the server of the present invention.

The present invention may include a component that is operable to enable a user to “check-in” with the server, in order to provide more information concerning power consuming events. This may be done by a user sending one or more communications to the server regarding for example what appliance has been turned on, e.g. “Dishwasher Is On”. These messages are used to enhance the information available to the server so as to then able the server to send communications to the user in order to make suggestions for reducing energy consumption. These messages may be time tagged and stored to the profile for the user or the location.

In one implementation of this aspect, the invention includes a computer program component that is operable to provide an interface that enables the user to provide information regarding resource consuming devices at the location, for example, by selecting appliances from a searchable menu of make/model/year items. This information is communicated electronically to the server and dynamically added to a profile associated with the user or the location. While information can be gathered from electrical signatures associated with specific appliances (based on the fact that appliances generally have electrical signatures that are unique, or at least as associated with a narrower set of possible appliances). These messages can be used to further pinpoint the specific identity of power consuming devices.

In another aspect of the invention, the present invention may be operable to identify gaps in the profile for the user or the location, for example, by identifying resource consuming devices for which identification information has not yet been obtained. For example, the system connected through a meter or meter reader to the location may detect when an unidentified power consuming device has been for example turned “ON”. In response, the system may send a communication to the user with the substance “AN APPLIANCE WAS TURNED ON AT [TIME]—WHAT APPLIANCE WAS THAT?”. Incentives, such as increasing currency rewards to users, may be provided to incentivize users to provide this information.

In another aspect of the invention, the computer program component for checking in is implemented as a mobile device client computer program that enables a user to collect relevant information regarding resource consuming devices, for electronic communication to the server.

By accessing this type of granular information, the system may be operable to suggest strategies for reducing consumption of a resource, such as for example replacement of an old appliance with a new appliance that is more efficient. From this perspective, sellers of appliance may have an interest in promoting the solution provided by the operator of the server, for example, by sponsoring specific content or placing advertisements on one or more web pages associated with the operator of the server.

In another aspect of the present invention, a user may share information concerning advantages of replacing a particular appliance with a new appliance to their network.

The user may also enable the server 1 to access and monitor one or more energy monitoring devices 11, which may include power meters, water meters, gas meters, etc. for a location 13. Typically the energy monitoring devices 11 are network connectable “smart meters”. The network connection may be made directly through a network connection between the server 1 and the energy monitoring device 11 or by linking the energy monitoring devices 11 to the client device's network interface. Alternatively, the server 1 can access the energy monitoring device information directly from a network connection of the energy provider 15, such as an energy company, water company, etc. Particular energy consuming devices may be network accessible. Optionally, these devices may be controlled (such as by turning the device on or off) by the user via the interface or by the server, for example where energy consumption must be reduced. Furthermore, legacy energy consuming devices (those without network connectivity) may be linked to controllers that are network connectable. The controllers may be controlled by the server for turning the energy consuming devices on or off The controllers may, for example, be network controllable power shutoff devices. The server may be configured by the user to: fully control the controllers (i.e., all of the time); particular control the controllers (e.g., control on/off based on a time schedule provided or agreed to by the user); or manually control the controllers (e.g., send a message to a user to turn on or off a device, or send a message to the user asking permission to turn on or off a device).

Computer systems of the energy providers may be linked by a network interface of the system to provide the server with carbon emission information, optimal operation information and peak profile information. The energy provider may also provide verification of user accounts. The carbon emission information may be provided as a cost of energy expressed as emissions, for example as kilograms of carbon emission per unit (e.g. Watt, Litre, etc.) of energy. The energy provider is typically in a position to determine at least approximately the emissions resulting from the production of each unit of energy. The optimal operation information may be provided as a utility output corresponding to an “ideal” overall consumption aggregated over all users. It may be desirable for the system to encourage users to consume less overall energy than the optimal output. The peak profile information may be provided as the maximum safe sustained output for the utility. During times of peak usage, for example on extremely hot or cold days, the system may take additional measures to encourage users to consume less energy than they otherwise would. The additional measures could include payment of relatively high amounts of currency.

As previously mentioned, the coordination utility may be operable to aggregate energy consumption schedules of a plurality of users associated with a particular utility, and consider the aggregated schedule when controlling energy consuming devices.

The system may also include one or more alternative energy devices linked to the location. The alternative energy device may not be linked to “the grid” but may be controllable via the server.

The interface may be provided as a graphical and textual “dashboard”. Each user may access an individualized dashboard that may display information including an aggregated baseline target, an aggregated baseline, and a peak electric baseline, if one or more of the energy monitoring device is for electricity. Users may navigate the dashboard and, in particular, drill down to view each of the baselines by individual modality and energy monitoring device. Users may also view their carbon emissions, reductions and targets. Users may also view community-based information including a consolidated dashboard organized by district, friends, country, family, teams, social network, etc. Additionally, forecasted warnings, suggestions and alerts may be displayed to users based on current usage habits, forecasted weather, seasonal device usage that is upcoming, and knowledge of users' schedules and energy needs. If one or more of the energy monitoring devices is for electricity, users may also view hourly, daily, weekly, monthly or any time interval, load profiles based on the profiles entered into the system. In accordance with a carbon trading system, described more fully below, users may also view their budget, earnings, and forecasted earnings.

Users may also access the interface to provide usage information to the server 1 regarding particular energy usage events. For example, the user interface may enable the user to provide messages, described above, by annotating load profiles or other graphical depictions of energy consumption. Users can enter free form text, for example, explaining spikes, sustained increases, etc. For example, a user may associate “cleaning staff were here” with a particular spike.

A user could alternatively send the usage information to the server by email, SMS or other message, and if the message is not parseable then the user may be prompted to clarify the information the next time they access the dashboard. For example, a user could use the interface to indicate usage of a dishwasher for 60 minutes, or could provide the information by SMS (e.g., “Dishwasher, 60”) or email (e.g., where subject line or body is “Dishwasher, 60”). Similarly, the user could access the interface to provide a household schedule or other information. Incentives, such as increasing currency rewards to users, may be provided to incentivize users to provide this information.

The system may be operable to enable the management and reduction of energy usage by: measuring the baseline energy consumption for one or more locations; managing energy consumption of the locations; quantifying energy savings corresponding to decreases in energy consumption for the locations; aggregating the energy savings of the one or more locations; commoditizing the aggregated energy savings; reselling the commoditized energy on a market.

Furthermore, a means for quantifying emissions reductions corresponding to the energy savings of each location may be provided. The system may be operable to enable the management and reduction of energy usage by: aggregating the emissions reductions for all locations into a tradable commodity; converting the tradable commodity into currency; and using the trading of currency as incentive for energy consumers to reduce energy consumption.

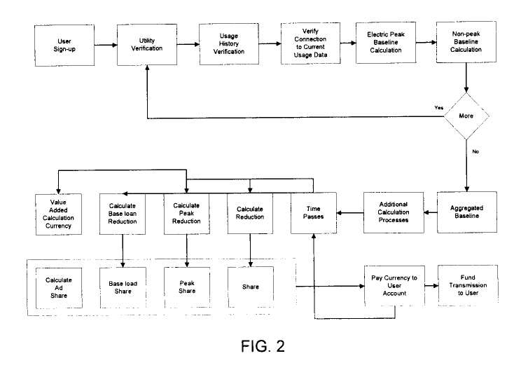

FIG. 2 illustrates a method in accordance with the present invention. A user may enrol with the system and provide account details corresponding to its energy providers, which the energy providers may verify. Upon verification, the energy provider may provide usage history to the system for saving to the database. The system may also verify a connection to the energy monitoring device and/or to the energy provider to obtain current usage data. Electric peak and non-peak baseline calculations may be performed, as described more fully below, for electric utilities. The process may be repeated for each energy provider the user wishes to associate with the system.

Once the user has associated all energy providers, the system may calculate an aggregated baseline and perform calculations for base load reduction, peak reduction, and overall reduction in usage. Based on the reductions, the user may acquire currency from the system.

The database may be preconfigured with and augmentable to record profiles for a plurality of energy consuming devices, such as appliances, furnaces, water heaters, lighting, fireplaces, etc.

Profiles may be provided for any known energy consuming devices. Profiles could be created by an administrator of the system, manufacturers, suppliers, users, etc. The system may also be able to derive profile information using the analytic information provided by the system if the user can provide information regarding usage of the particular energy consuming device. For example, by analyzing energy usage before and during usage of a particular device, the net consumption caused by the device can be obtained.

The system may provide the user with analytic information regarding energy consumption. Users may be provided with means, such as the interface, for configuring the system to provide relevant analytics, including for example by providing location information, energy monitoring device information, profile information, consumer usage information and/or cost information. Any or all of this information may be used for providing analytic information and predictive modeling. For example, the user may provide a list of all energy consuming devices, such as appliances, etc., at the location for each of the energy modalities desired. The user can also provide costing information of energy consumption for each modality. Energy providers may provide the system with carbon emission information. For example, the carbon emission information may be provided as kilograms of carbon emission per unit of energy.

Location information may include a physical or geographical location, such as an address. Users may also provide specific information about the location, such as size and/or type of unit (house, commercial, industrial, condominium, etc.) and structural attributes including insulation type, window type, etc. The system can use the location information and aggregated location information to determine the footprint of the location and the realistic energy needs for the location. This information may be used, for example, in determining a base load, which is described more fully below.

Energy monitoring device information may include means for enabling the computer server to communicate with the energy monitoring device, such as the specification of proprietary communication protocols, and/or details about the user' account with one or more providers of energy modalities (the utility companies). The server may communicate on a frequent or intermittent basis to obtain energy consumption information (i.e. the load profile) for each modality of the location. The energy consumption information may be obtained directly from the energy monitoring device, if it is operable to provide the energy consumption information, or from the energy provider. The load profile may enable optimal use of the analytic information to provide predictive modeling based on changing the user's energy consumption behaviour.

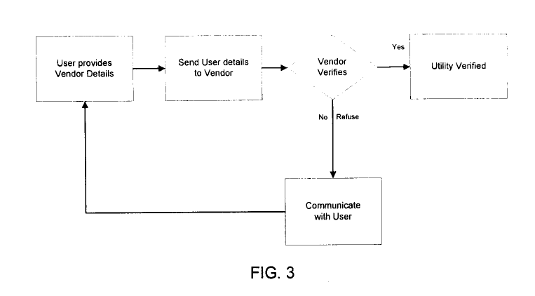

The account details may be used for obtaining from the provider via the network a set of historical usage information, including maximum historical usage for the user, and/or energy consumption information (as described above). The historical usage information may be recorded to the database. The account details may also be used to periodically verify that the user is associated with the particular energy monitoring device associated with the modality. FIG. 3 illustrates a user verification routine. The user may provide details of each of its energy provider accounts, including energy provider identification, account identification, location, meter number, etc. These details are sent to the energy provider. The energy provider either verifies or refuses to verify the account details. If the user is not verified, the system may infer that there is a new resident of the location. The former resident could also be tracked to their new location and the information they previously provided could be used in a new configuration for the new location.

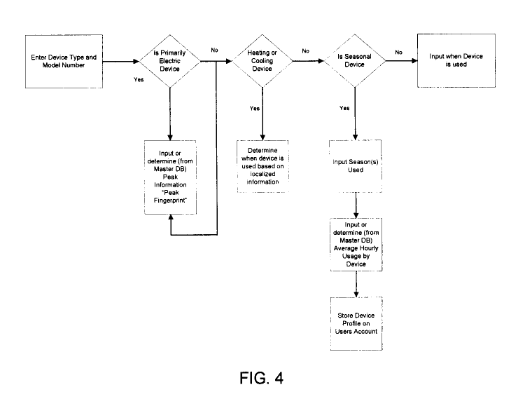

The profile information may include device consumption information. The device consumption information, for example, may be provided as an energy usage per hour. The device consumption information is typically made freely available by device manufacturers. FIG. 4 illustrates a user configuring the system by providing profile information for energy consuming devices. The user provides profile information including, for example, device type and model number. If the device is a primary electrical device, it may be associated with a peak usage and peak usage information may be provided. Otherwise, if it is a heating or cooling device, information may be provided regarding times of usage. If it is a seasonal device, information may be provided regarding in which season it is used, and hourly (or any other time interval) usage. For all devices, the user may specify when the device is typically used, either hourly, daily, weekly, monthly, annually, etc.

Users may also provide consumer usage information. For example, in a household setting of a plurality of occupants, the consumer usage information may correspond to device usage habits for each occupant based on the times of day, week, year, etc. that the occupants are at home or away.

Users may also provide cost information for assigning a cost per unit of energy for each modality. The cost may be time variable (for example based on hour of day, day of week, etc.) or constant. Alternatively, the cost information can be provided by the energy provider.

The system is operable to provide analytic information based on the location information, energy monitoring device information, profile information, consumer usage information and/or cost information. The analytic information may, for example, include graphical and/or textual representations of energy use, energy reduction, and energy cost. The system may enable the user to specify parameters for developing a predictive model for estimating energy usage and/or cost based on altering the user's energy consumption behaviour or replacing energy consuming devices. The predictive model may be provided in the same representation as the analytic information. For example, a chart may be displayed in which the predictive model and the analytic information are displayed on an overlapping basis, providing a user with a readily understandable interpretation of potential energy reductions and savings, enabling a user to see the particular energy savings achievable based on the specified behavioural change.

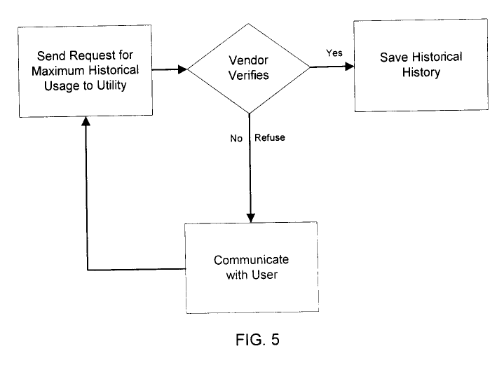

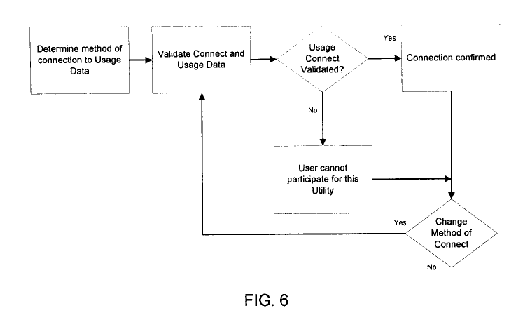

The analytic information is based on one or more collected data. The collected data could, for example, be simply the energy usage from one of the energy monitoring devices. The collected data could be provided by the energy provider. FIG. 5 illustrates a provider usage verification process. The energy provider may verify or refuse to verify the collected data. The collected data may be saved as historical data if verified. Otherwise, the user may be asked to reinitiate the verification process. The collected data could also be provided by the user where the energy monitoring device is operable to communicate with the server. FIG. 6 illustrates a user providing collected usage data. The collected usage data may be collected from a smart meter, which the user or energy provider may verify, resulting in saving the collected data as historical data.

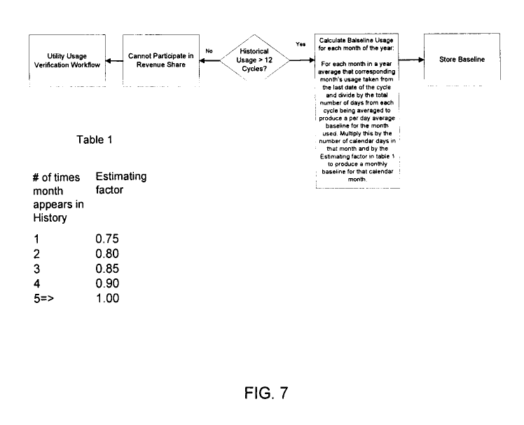

The collected data may be stored in the database as historical data. A baseline usage may be calculated based on the collected data. The baseline usage may represent an estimate of usage for a given time period, such as hourly, daily, weekly, monthly, yearly, etc. FIG. 7 illustrates the calculation of baseline usage. The data may be collected and/or displayed on a periodic basis. The period could be real time, hourly, daily, weekly, monthly, or any time interval or could be on an ad-hoc or triggered basis.

There may be a minimum amount of overall data required prior to enabling analytic features. In a particular example, analytic features may not be available until one year of historical data has been collected and the cycle of data collection may be per month. Thus twelve cycles may be required to enable analytic features. In another example, the historical data required for analysis may be more or less than the twelve cycles. Furthermore, in order to ensure that users experience energy savings predicted by the predictive models, the baseline usage may be conservative where little historical data is available. When a sufficient amount of historical data is available, the baseline usage may be more reflective of actual usage. A sufficient amount of historical data may, for example, be five years worth of the particular month's usage. Where there are less than five samples available, an estimating factor may be used for conservatively estimating the relevancy of that data to predictive models. Furthermore, the cycle may not correspond exactly with the calendar month, due to data collection policies of the energy provider. Thus the data gathered in the cycle may be processed to determine a monthly baseline. For example, the total usage of the cycle may be divided by the number of days in the cycle and multiplied by the number of days in the calendar month. The final number may be multiplied by the estimating factor, which may be 0.75 for 1 sample of the month, 0.80 for two samples, 0.85 for three samples, 0.90 for four samples, and 1.00 for five or more samples. It should be understood that these thresholds and factors are merely for illustration and can be made any number as appropriate.

Alternatively, when a user becomes associated with the system and there is insufficient energy use history for the user, the server can collect smart meter interval data and the analytic utility may compare an energy signature for the new user to those of already associated users to determine one or more best matches of energy use profiles. The average of the one or more best matches can then be used as the energy use profile of the new member.

Based on the user inputs and the analytics, the server may be operable to provide an energy reduction path for a user to optimally reduce energy consumption. The energy reduction path may be accessible to the user from the interface. An energy reduction path may be calculated by the server based on known energy consuming devices that the user has, the device usage requirements to maintain their reduction tolerance, the local utility requirements and display for the user a simple to understand and read weekly schedule for when to use or not use devices to maximize their reduction and peak shaving.

Alternatively, when a user becomes associated with the system and there is insufficient energy use history for the user, the server can collect smart meter interval data and the analytic utility may compare an energy signature for the new user to those of already associated users to determine one or more best matches of energy use profiles, which can then be averaged to determine one or more best matches of energy reduction paths for the user.

The maximum benefit and reductions can be calculated by combining the user's habits, desired lifestyle, known devices, weather forecast, and local utility optimal operations, and will include and aggregate all energy reduction paths for all users using the same utility. By aggregating all user's energy reduction paths, the server can have an immense impact on real time usage within a utility district. For example, by monitoring all users in one utility district utilizing the peak service, the server can communicate real time with the users to ask them to participate in peak reduction at any point in time. Energy consuming devices linked with the server can be managed remotely, with permission of the user, and turned on or off to maximize peak shaving. As previously mentioned, the coordination utility may turn energy consuming devices on or off so as to prevent infrastructure damage.

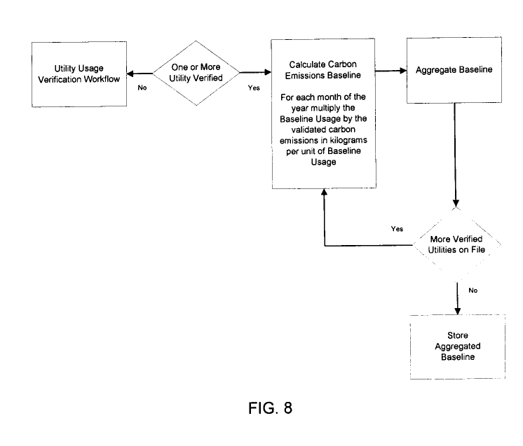

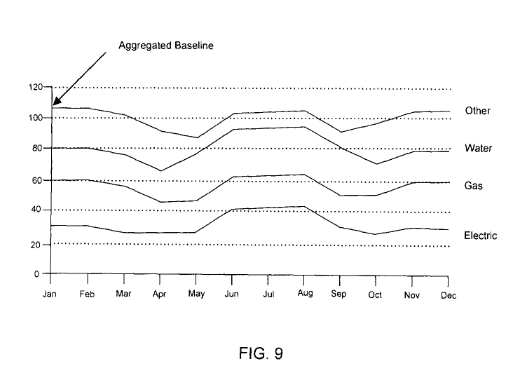

FIG. 8 illustrates the calculation of an aggregated baseline taking into account all energy modalities. As previously mentioned, energy providers may provide the system with carbon emission information. For example, the carbon emission information may be provided as kilograms of carbon emission per unit of energy. For each of the energy providers that have provided carbon emission information, the user's monthly baseline for each modality can be multiplied by the carbon emissions per unit of energy for that modality to provide a baseline carbon emission, which may be stored to the database. By aggregating each of the baseline carbon emissions for all the modalities, an aggregated baseline may be provided. The baseline carbon emissions and the aggregated baseline may be displayed graphically. FIG. 9 for example illustrates an aggregated baseline for the modalities “water”, “gas”, “electric” and “other” for a one year period.

The analytic information can be further broken down based on the profile information provided by the user. For example, a user can determine usage information for each of his or her appliances for a given time period.

Predictive models may enable users to adopt best practices for reducing energy consumption and/or energy cost including by suggesting altered user behaviour and/or energy consuming device replacement. Predictive modeling, based on the analytic information and responsive to location information, energy monitoring device information, profile information, consumer usage information and/or cost information, may be operable to forecast users' energy usage based on changes to profiles and/or user behaviour. The predictive model may also be responsive to a base load calculation.

A base load calculation may describe the minimum safe energy usage and/or carbon emissions produced at the user's location in a typical low-usage state, such as when the user is sleeping or away from the location. The base load calculation may be calculated based on historical usage data The base load calculation may be continually re-calculated based on current location information, energy monitoring device information, profile information, consumer usage information and/or cost information and user usage/analytic information.

The base load may, for example, be calculated by analyzing the lowest energy usage based on existing energy consuming devices taking into account seasonal and time factors. The base load calculation may be configured to maintain the “lifestyle” of the user, for example by not materially affecting the overall benefits of using the user's energy consuming devices. Seasonality may affect the base load for where applications require higher/lower energy usage based on season. One goal of the present invention is to calculate a base load goal that enables users to continue with at a lifestyle level with lower energy usage by analyzing energy usage above the base load and suggesting behavioural changes or controlling energy consuming device usage.

The predictive model may consider the base load calculation to form a forecast. The forecast may include behavioural suggestions for the user to reduce energy usage and/or cost. The behavioural suggestions, for example, may include optimal times to use particular energy consuming devices and/or optimal times to eliminate usage of two or more energy consuming devices at a time. The behavioural suggestions may also be implemented directly to one or more network connected and software configurable energy consuming devices. For example, these devices may be actively managed by the system or may interface with the system to display warnings or other suggestions or a user interface. The coordination utility may provide users with behavioural suggestions based on preventing damage to infrastructure, for example by suggesting that a first user turn on a device at a time staggered from the time suggested to a second user.

Users may configure a reduction tolerance. The reduction tolerance may be configured using a sliding scale to set the user's tolerance on how much of a reduction they are willing to achieve. The lowest reduction tolerance may be zero, which may signify present consumption and no desired reduction. Setting this scale to a maximum may yield maximum reduction but would require the user to potentially make major changes in his or her energy usage and, therefore, lifestyle. The maximum reduction may not result in lower usage than the base load calculation, however the base load calculation may be reduced by eliminating or reducing consumption from one or more energy consuming device altogether.

Users may monitor, via the interface, their hourly, daily, weekly, or any time interval, usage. The user may compare the usage to their preconfigured goals (based on the reduction tolerance). The interface may alert the user, whether positively for achieving goals or negatively for exceeding usage, along with suggestions to correct negative behaviour before the end of usage cycle. Possible suggestions may be based on any or all of current weather predictions, knowledge of users' devices, users' usage and knowledge of users' schedule and household needs, and knowledge thereof of aggregates for a plurality of users.

Users may also access a device analyzer via the interface. The device analyzer may provide users with information based on adding, removing or replacing energy consuming devices. For example, if a user is considering purchasing a replacement appliance, the user may configure the system by replacing an existing appliance profile with a profile for the appliance under consideration. The interface may display the difference in energy usage using a predictive model to assist the user in making a purchasing decision. The usage difference may be a positive impact (reduction in energy), meaning no offsets would be required, or may be a negative impact (increase in energy), meaning that the user may have to offset the increase. The offset may be made by adopting one or more behavioural suggestions made by the predictive model of the system. For example, a suggestion may include replacing another device with a more efficient one or purchasing a difference replacement device (one with a lower energy usage) than the one under consideration.

Users may also access a suggested low energy path. The low energy path may be displayed as a simple to understand schedule for when to use the particular energy consuming devices in order to maximize the user's energy reduction and peak energy shaving. A low energy path may be calculated by the system based on the profile information. The system may consider the energy consuming devices and device usage requirements to maintain the user's reduction tolerance. The system may calculate scenarios wherein a maximum benefit and reduction can be achieved by combining the user's habits, user's desired lifestyle, energy consuming devices, weather forecast, and the energy provider's optimal operation information. Furthermore. based on the optimal operation information, the system may be operable to aggregate all low energy paths for all users linked to the particular energy provider. By aggregating all paths an immense impact can be made on real time usage of the energy output by the energy provider. This can be used to efficiently allocate energy usage for all users linked to the utility so as to distribute usage over peak and off peak times. For example, users may be presented a schedule that encourages them to operate energy consuming devices during off peak times. The schedule may be devised by considering usage habits and possibilities of other users.

By monitoring all users for a utility, the system can communicate with individual users using alerts to ask them to participate in peak reduction at any point in time. Furthermore, some energy consuming devices that are network connectable may be managed remotely by the system, with permission of the user, by turning them on or off to maximize peak shaving.

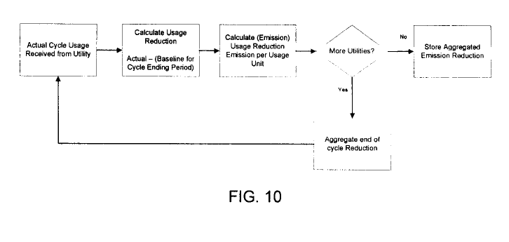

FIG. 10 illustrates an emission reduction process. For each user, the system may collect data at the end of a cycle, as previously described. The system may calculate the usage reduction for the cycle as the actual usage minus the baseline usage for the cycle ending period and the emission reduction as the usage reduction multiplied by the emissions per usage unit. The calculation may be aggregated for all energy providers for the user, and stored as an aggregate emission reduction.

Currency may be provided by the trading utility to users based on user-specific consumption reductions, overall system energy consumption reduction, particular programs for encouraging reduction in consumption, and/or advertising.

The trading utility may exchange a user's energy usage reductions (carbon credits) for units of currency. The carbon credits can be resold on an internal market or sold or pooled for selling on a carbon market and/or commodities exchange market (the open market). The currency can be used for exchange on an internal market, for example as carbon reduction futures to other users of the system. Base load reduction futures and peak demand reduction futures may also be sold to users, encouraging further reductions. In accordance with the trading utility, users may view their budget (based on the currency), earnings, and forecasted earnings via the interface.

Units of currency can be awarded to users based on their energy reductions, in exchange for assigning to an administrator of the system the reduction in carbon emissions and/or profits realized from selling excess (unused) energy on the open market. Each user may manage their budget including by exchanging them for legal tender. For example, the currency may have an exchange rate relative to any legal tender. The exchange rate may be determined by tying it to a specific legal tender (or a basket of legal tenders) plus an optional “transaction fee %” calculated by determining the cost of an exchange. The exchange rate could also be determined in part by the transactions incurred on the internal market and the open market as currency is traded, providing a fluctuating exchange rate determined by market forces.

A plurality of programs may be used to encourage users to reduce energy consumption, earning them units of currency and assigning to the system any carbon credits achieved to enable the trading utility to commoditize the carbon credits on the open market. The programs may include a baseline consumption reduction program and a peak consumption reduction program.

Users may also earn units of currency by sharing in profits of the system derived from carbon trading, commodity trading (from electric, water, gas, etc), electric peak shaving, and/or advertising from the open market.

Users may be further encouraged to reduce energy consumption on a per user contract basis. Users may enter into binding contracts under which they promise particular levels of energy reduction in exchange for additional currency. The contracts may be optional. If the user meets the agreed target reduction they may be paid, but no payment may be made for not meeting the target. Electric users may be paid based on reduction from peak usage based on the electric peak baseline. Furthermore, a base load reduction share may be calculated by multiplying each user's net base load reduction by a contracted amount, which may then be converted to currency.

For example, a user may enter into a Normal Demand Reduction Program (NDRP) contract with an administrator of the system. The contract may require that a user agrees to change their habits, replace energy consuming devices, and/or purchase alternative energy devices to offset normal peak patterns. A particular target reduction may be required under the contract. The system may determine based on the location information, weather information, energy monitoring device information, profile information, consumer usage information (including behavioural information), cost information, and/or historical information (which may include further behavioural information), one or more suggestions to the user to lower his or her peak usage during normal high peak times for the energy provider, based on input from the energy provider. NDRP engaged by one or more users (e.g. an aggregated energy usage reduction) may result in a lowering of the required energy output by the energy provider during peak times. The energy provider's output between this reduced amount and its capacity could then be resold as a tradable commodity on a market. Profits realized may be sent fully or partially to the system and may be shared with the users, particularly those users that entered into the NDRP contract and if they meet the required target reductions. The profits may be governed by a net NDRP reduction that may be the aggregate of the reduction from each cycle for the user. The aggregate may include a positive contributor for each cycle that shows a reduction at least of the target reduction, while consuming energy above the target reduction may be a negative contributor.

Some or all users may also enter into a High Demand Reduction Program (HDRP) contract with an administrator of the system. HDRP may operate similar to NDRP but may be engaged during times of peak demand. Users entering into a HDRP may be rewarded beyond the amount provided under NDRP. The HDRP may request that enrolled users reduce energy consumption at particularly high electric demand periods. These periods may occur based on weather extremes (hot/cold), reduced power availability and/or other factors putting a demand strain on the energy provider's output capacity. During HDRP periods, the energy provider's peak profile and the energy reduction path for enrolled users may be adjusted to accommodate further reductions to relieve the strain on the system. The overall system energy consumption reduction may be most valuable during these periods as energy providers may be willing to compensate the users of the system with higher payments during these periods.

In particular, an enrolled user's network connectable energy consuming devices may be automatically turned off. Enrolled users' reduction tolerance may also be disregarded during HDRP periods to enable the system to suggest steps for enabling major energy consumption reductions.

It may be desirable to limit the users that can access the HDRP to those users with a long term relationship with the system and those users that are likely to meet reduction targets.

The HDRP reduction for which to enable a reward to a user may be calculated as the further reduction in peak demand. The reward may be highest for those enrolled users that respond fastest to HDRP reduction requests. The HDRP reduction may be the difference between the user's Normal Demand Reduction program requirements and the user's lowest kilowatt peaks for each HDRP program period.

A net HDRP reduction may be calculated by aggregating each HDRP period reduction. When aggregating each interval a reduction below the user's Normal Demand Reduction program may be considered a positive contributor, while going over the Normal Reduction may be considered a negative contributor.

A peak share calculation may be provided by multiplying the net High Demand Responses Program (HDRP) and a contract value per unit, plus multiplying the net NRDP and a contract value.

The trading utility may calculate a user's currency award by multiplying its overall system reduction, or reduction of a specific modality, relative to the user's baseline for a given time period based on the exchange rate. The time period could be continually, hourly, daily, etc. The user can then choose whether to exchange the currency for legal tender based on existing exchange rate between the currency and the legal tender, hold the currency in the user's account, sell the currency on the internal market, or transfer the currency to be held by an administrator of the system (for example, as a donation to enable a tax credit to the user) so the administrator can direct the trading utility to aggregate the currency, which the administrator can hold, sell on the open market, or disburse to other users.

When a user releases currency to the administrator, the trading utility may enable the user to link its name to the credit. When the currency is later commoditized, the user's name can be advertised to the community or to the purchaser, and the user can be notified of the purchase. Users that are active in the releasing of currency can be ranked and the ranking can be made public to provide a wall of fame on each user's interface or through advertising. This further incentivizes exchange of currency. Other incentives can include virtual badges that can be earned by users for achieving specific goals. Badges earned could be single achievements, multiple achievements, or combination of different achievements. Badges could include records for most reduced days (i.e., most below baseline days in a row), lowest day of the week, best week, and best month.

A user could also sell currency on the internal market. This can be done by auction, for example. The user could put up a specific number of units of currency for auction to the highest bidding user. The auction could be open for a specific time period.

The trading utility may also be configured to provide promotional offers to users (or outside entities) to enable further energy reduction. For example, users could be offered a premium currency award for reductions during particularly high-demand energy periods, or could be offered premium currency awards in exchange for particular behaviours, such as purchasing particular reduced-energy energy consuming devices, electric vehicles, etc. Premium currency awards could also be provided based on geographical location to incentivize reductions in particular locations.

The trading utility is operable to maintain a legal tender-backed volume of currency units by disbursing currency units based on the exchange rate between currency and legal tender. The trading utility enables an inflow of legal tender from outside entities and users. For example. an outside entity can purchase, from the trading utility, carbon credits that are based on the aggregated units of currency allocated to the administrator of the system. These purchases could be made by auction or on an established market index (trading exchange). In this way. the trading utility is responsive to market conditions on the open market, which can affect the value of the currency to users.

The trading utility may also enable users to purchase electricity or electricity futures in exchange for legal tender. For example, a user that knows it is likely to exceed its baseline in a particular month could purchase currency for legal tender to offset the energy increase. Users could also purchase additional currency to reduce their energy consumption beyond the baseline, for example up to zero usage. Users may also purchase carbon credit reductions, energy reductions and peak demand reductions. These purchased credits may then be given to other users who meet their goals in equal amounts. The user who purchased can then claim the reduction on the internal market or external market.

Outside entities can also purchase advertising from the administrator, which enables all or part of the advertising revenue to be allocated to further currency that can be disbursed to users and part of which may be retained by the administrator, or to inflate the value of the currency. Advertising could also be purchased by users by exchanging currency for advertising space.

The system may be linked to an advertising engine for displaying advertisements. The advertisements may be displayed on user's interfaces or could be pushed to users, by SMS for example. The duration and location of advertising can be responsive to the value of the payment by the advertiser. Adverting revenue can be based per-impression and/or per-click. The displayed advertisement may be based on any or all of: information provided by the user in their user profiles, device profiles, user habits, real time energy usage and electric peak.

Displayed advertisements may be based on: a) the current energy consuming devices the user owns; b) known habits of the user either gathered over time by analysing their usage or input into the system by the user; c) the location of the user; and/or d) weather patterns/history in the area. For example, this information may enable the display of advertisements for replacement devices or controllers that would optimize energy reduction. It may also enable the display of advertisements for third parties that the user can transact with to reduce the user's own energy usage, such as a restaurant so the user would not cook at home.

To avoid conflict of interest, a user's share of advertising may exclude ads they have clicked on or had an impression of and other conflict of interest criteria. Earnings from advertising may be calculated by a cooperative method of each user getting an equal share of the system profit from advertising. To avoid conflict of interest, users may not be provided with a share of advertising that they have clicked on or had an impression of. Other conflict of interest prevention criteria may also be provided.

Furthermore, advertisers that are users may be further rewarded for energy reduction by augmenting their advertising bid. For example, an ad user that is below their target in the prior month by 10% and bid $1.00 for a click, can have their bid increased by $0.10 for free.

The present invention may also include or be linked to a social networking utility. The social networking utility may implement a social network or interface with an existing social network, for example through an application programming interface. The social networking utility may enable a user to create and maintain an energy saving social network.

Users that are members of the social network may invite other social network contacts to join their energy saving social network. Invitations can also be sent through other media, such as email, to invite non-users and non-social network contacts to join the energy saving social network. Non-users that accept the invitation can be converted to users by the registration steps described herein.

The social networking utility is operable to track which new or existing users have joined a particular user's energy saving social network, and can generate aggregated energy savings information for that energy saving social network, optionally broken down by the number of depth of associations between the inviting user and the accepting users. If a plurality of energy saving social networks intersect by having one or more shared users, then the social networking utility may be operable to track the userbase of each energy saving social network and the aggregated energy saving social network.

The social networking utility may include or be linked to a power plant display utility that is operable to generate an illustration depicting energy savings of a user, a user's energy saving social network, and/or a particular depth of the energy saving social network. For example, the illustration may be of a virtual power plant, and the volume of energy savings may be depicted by illustrating a particular size or completion of the power plant. The power plant could also be compared to actual power plants to provide users with context to understand their energy savings. Actual power plant information can be provided by the administrator of the system.

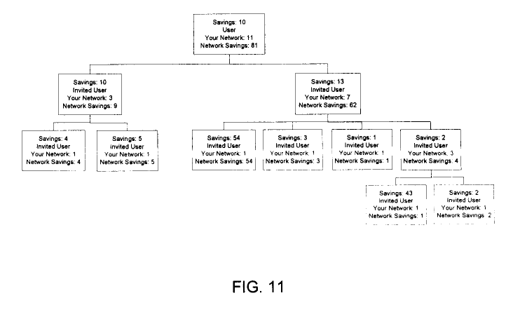

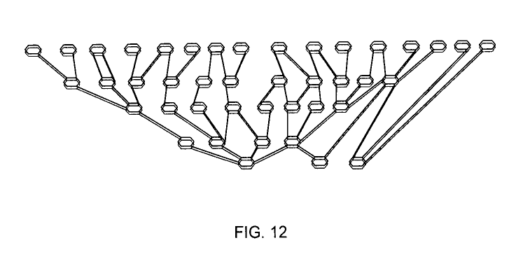

The illustration could also be a tree-based illustration. FIG. 11 illustrates aggregated energy reduction achieved by a network of users in a tree-based illustration showing the user's energy reduction, number of users in the social network and aggregated energy reduction for the social network. Another tree based illustration of a power plant, that may resemble a growing plant (flora) is shown in FIG. 12.

Users may also access, from the power plant display utility, for example by clicking the illustration, analytics corresponding to the aggregated analytics of the users in the energy saving social network and/or a particular depth of the energy saving social network. The analytics could include total carbon emissions reduced; total electricity produced (based on savings) in lifetime, last month, last week, yesterday or date range; totalized highest peak reduction at a particular hour and date by lifetime, last month, last week, yesterday or date range.

The social networking utility may also gather data about social network users to create a profile. Profiles can be matched based on a plurality of criteria in order to, through the matches, enable users to be motivated to reach their energy reduction goals. For example one user with obstacles to meeting their goals may be matched with one or more other users who had similar obstacles but were able to overcome them. Based on these matches, the social networking utility is operable to dynamically enable the creation of support groups for encouraging energy reduction.

The following user scenarios illustrate some benefits of the present invention, without limiting further scenarios that are possible in accordance with the present invention.

A user may reside in a region in which energy providers are associated with the system. The user may have been associated with the system for 14 months. Upon joining, the user may enter into a contract with the system to lowering the user's electric usage to at least their reduction tolerance, below his or her 5 year average, which constitutes that user's baseline. The contract may also authorize the system to communicate directly with the user's energy provider to access the user's smart meter reads, reading history and billing history.

The user may have found that meeting his or her base demand goal was relatively easy and soon signed up for the High Demand Reduction Program (HDRP) on a trial basis. This program allows the user to receive High Demand Reduction requests through an API on the user's smart phone. The user may choose to reduce his or her usage but until committing will not receive any income. After two months the user determines that he or she does want to participate in the program and signs the contract with the system to commit to reduce demand on request. The user understands that the faster he or she responds the higher the rate he or she receives for the reduced capacity.

The user may experience positive results but may want to extend reduction to those times when the user is travelling and often not home when power reduction opportunities occur. The user may have, or invest in, network connectable energy consuming devices, and configure the devices for use with the system. The system can automatically turn off the devices in times of High Demand, increasing the rewards and decreasing energy bills for the user.

The user may also install one or more alternative energy devices, such as solar roof panels with network connected controllers, on his or her house. The panels may be enabled by the server via the controllers during HDRP periods. During a HDRP period the panels may be brought online via the controller thus dropping the peak load even further. The user may realize that this type of installation does not require that the panels be connected to the grid and does not require a net meter. Further, the user would not have to deal with payment disputes with the energy provider or the possibility of the panels going offline due to the fact that the grid cannot deal with the variances of the current panels from the neighbourhood are producing. The panels can also be used as an energy offset when the system sends alerts to the user that his or her base load target may be exceeded.

The user may also have collected a high amount of system currency. The currency may be exchanged for network connectable controllers for the user's legacy energy consuming devices. These controllers may enable the system to control even the otherwise non-controlled devices to further automate energy reduction measures.

The energy provider may implement different rates at different times of the day. The user's meter may be a smart meter, enabling the system to track usage based on time of day. The system may suggest to the user optimum times to operate appliances and other energy consuming devices during off peak periods to achieve minimum energy cost.

If the energy provider is unreliable or known to have periods of no energy output, the system may also send the user alerts of high demand and planned outages to enable the user to plan usage efficiently.

It should be understood that based on the user interface of the present invention, it is operable to provide additional features by nature of its capabilities, including for example: security monitoring wherein a spike of usage while a location is unoccupied indicates a security breach; monitoring of other occupants of the location whereby an increase in usage could signify a “party”; power outage notifications; tampering/theft of power; line loss/water loss notifications; water leak notifications based on excessive consumption; voltage/power spike analysis; and/or tolerance alerts whereby custom alerts may be created by the user to alert them to various overages in tolerances such as x% over last week at the same time, etc.

Further extensions include building a large database of users to enable prediction of and shifts in electricity, gas, water consumption and other energy usage. This enhanced information may enable an administrator of the system to negotiate favourable capacity contracts with energy providers or other entities tied to energy providers, such as government bodies. Bids can be accurately tailored for implementing the present invention with these energy providers, as accurate figures will be available.

We claim:

1. A computer implemented method of managing and reducing energy usage, the method characterized by:
(a) establishing a base line energy consumption for one or more users;
(b) monitoring, by means of one or more energy monitoring devices, energy consumption for the one or more users;
(c) providing access to one or more tools by operation of a computer system, that enable the one or more users to reduce their energy consumption;
(d) determining energy savings by operation of the computer system by calculating reduction in energy consumption based on the base line energy consumption for the one or more users; and
(e) aggregating the energy savings across a plurality of users, and commoditizing the energy savings by operation of the computer system.

2. The method as claimed in claim 1, wherein the energy savings are commoditized into a digital currency by operation of the computer system, the method characterized by the further step of enabling the one or more users to trade the currency.

3. The method as claimed in claim 2, characterized in that the currency is auctioned off to other users.

4. The method as claimed in claim 1, wherein the energy savings are commoditized into carbon credits, the method characterized by the further step of selling the carbon credits on the open market in exchange for revenues.

5. The method as claimed in claim 4, characterized by the further step of distributing a portion of the revenues resulting from the sale of the carbon credits to the one or more users.

6. The method as claimed in claim 1, characterized in that the one or more energy monitoring devices are linked to one or more energy consuming devices, each energy consuming device being associated with a profile of energy usage.

7. The method as claimed in claim 6, characterized by the further step of suggesting one or more replacement energy consuming devices based on the replacement energy consuming devices having profiles that will reduce energy consumption for the one or more users.

8. The method as claimed in claim 6, characterized by the further step of suggesting changes in one or more users' energy usage behaviour, based on the profiles, to reduce energy consumption.

9. The method as claimed in claim 8, characterized by suggesting the changes for a plurality of the users to provide a maximum aggregated energy savings.

10. The method as claimed in claim 1, characterized by the further step of incentivizing the one or more users to reduce energy consumption by publishing a ranking of users based on energy savings.

11. The method as claimed in claim 1, comprising the additional steps of:
(a) obtaining information regarding load balancing requirements, which may include peak demand energy requirements;
(b) establishing a demand reduction program by identifying one or more users associated with the computer system that, by providing energy savings in aggregate, are able to delivery energy savings relative to their aggregated baseline that meet the load balancing requirements, in whole or in part; and
(c) realizing energy savings on an aggregated basis, by operation of the computer system, that meet the load balancing requirements, in whole or in part.

12. The method of claim 11, comprising the further step of monetizing the energy savings based on payments in exchange for meeting the load balancing requirements.

13. The method of claim 11, wherein the computer system is linked to one or more consuming devices associated with the one or more users, and wherein the computer system is operable to shut off the one or more consuming devices, or a sub-set thereof, based on participation of the associated one or more users in the demand reduction program.

14. A system for managing and reducing energy usage, the system characterized by:
(a) one or more energy monitoring devices operable to monitor energy consumption for one or more users;
(b) a server linked to the one or more energy monitoring devices, the server operable to:
(i) establish a base line energy consumption for the one or more users;
(ii) provide access to one or more tools for enabling the one or more users to accomplish reduction in their consumption of energy;
(iii) validate energy savings resulting from the reduction in consumption by the one or more users based on the base line energy consumption for the one or more users; and
(iv) aggregate the energy savings across a plurality of users, and commoditize by operation of the computer system.

15. The system as claimed in claim 14, characterized in that the energy savings are commoditized into currency that can be traded among the users.

16. The system as claimed in claim 15, characterized in that the currency is auctioned off to other users.

17. The system as claimed in claim 14, characterized in that the energy savings are commoditized into carbon credits, the carbon credits being sold on the open market in exchange for revenues.

18. The system as claimed in claim 17, characterized in that a portion of the revenues are distributed to the one or more users.

19. The system as claimed in claim 14, characterized in that the one or more energy monitoring devices are linked to one or more energy consuming devices, each energy consuming device being associated with a profile of energy usage.

20. The system as claimed in claim 14, characterized in that the server is operable to suggest one or more replacement energy consuming devices based on the replacement energy consuming devices having profiles that will reduce energy consumption for the one or more users.

21. The system as claimed in claim 14, characterized in that the server is operable to suggest changes in one or more users' energy usage behaviour, based on the profiles, to reduce energy consumption.

22. The system as claimed in claim 21, characterized in that the server is operable to suggest the changes for a plurality of the users to provide a maximum aggregated energy savings.

23. The system as claimed in claim 14, characterized in that the server is operable to incentivize the one or more users to reduce energy consumption by publishing a ranking of users based on energy savings.

24. The system as claimed in claim 14 characterized in that the server is linked to a social networking utility, the social networking utility operable to enable the one or more users to invite other users, or one or more non-users, to join a social network to promote further energy savings.

25. The system of claim 14, characterized in that the system is operable to:
(a) obtain information regarding load balancing requirements, which may include peak demand energy requirements;
(b) establish and implement a demand reduction program by identifying one or more users associated with the system that, by providing energy savings in aggregate, are able to delivery energy savings relative to their aggregated baseline that meet the load balancing requirements, in whole or in part; and
(c) realize the energy savings by operation of the one or more tools that on an aggregated basis meet the load balancing requirements, in whole or in part.

26. The system of claim 25, comprising the further step of monetizing the energy savings based on payments in exchange for meeting the load balancing requirements.

27. The system of claim 25, wherein the system is operable to shut off the one or more consuming devices, or a sub-set thereof, based on participation of the associated one or more users in the demand reduction program.
